(19) United States
(12) Patent Application Publication
(10) Pub. No.: US 2002/0186670 A1
(43) Pub. Date: Dec. 12, 2002

(54) Video and sound signal broadcasting system applicable to railways

(75) Inventors: Jaime Fuster Rufilanchas, Madrid (ES); Fernando Trapero Jimenez, Madrid (ES)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MEDIATRANS TECH SOLUTIONS, S.L., Pozuelo De Alarcon (ES)

(21) Appl. No.: 09/887,001

(22) Filed: Jun. 25, 2001

(30) Foreign Application Priority Data
Jun. 8, 2001 (ES) P200101337

(51) Int. Cl. H04Q 7/00

(52) U.S. Cl. 370/328; 370/338

(57) ABSTRACT

A video and sound signal broadcasting system applicable to railway carriages (1), equipped with terminals formed by television and sound screens, consisting of a transmitter head subsystem of the signal to be presented, a transmission subsystem responsible for sending the signal to the carriages and an on-board equipment subsystem, inside the convoy carriages. The head subsystem receives the signal, coded in MPEG 2 format and inserted in a Gigabit Ethernet telecommunications network, available in the metropolitan railway network, whilst the transmission subsystem consists of a broadcasting device (4) located in each station, consisting of three antennas: two one-way (2) at the mouth of each tunnel (5) and another omni-directional one (3) giving coverage to the station connected to the GigaEthernet network and the on-board subsystem on trains consisting of a reception and exchange control, power supply and TFT screens.

This invention concerns a video signal broadcasting system, applicable to railways, consisting of a new and original video signal broadcasting system in real time, to vehicles in movement, both along surface or aerial tracks or underground.

Therefore, the invention proposed will be of special interest for the manufacturing and supplying sectors of telecommunications equipment and installations, in devices used mainly by the railway industry.

The state of the art regarding this type of telecommunications system with mobile units, like railway convoys, is defined by a wide range of devices. The most primitive lack external communication means, the video signals transmitted in the carriages of a convoy being only those reproduced therein, by means of a video player or similar equipment. Said signals are conveyed by the appropriate circuits (in general, wired) through the corresponding carriages to the different terminals equipped with their corresponding screens.

The development and cheapening of video signal based communication means and particularly, the possibility of their transmission by compressing the signals in high capacity formats, such as MPEG (motion picture experts group) and sending said compressed information through telecommunications networks, such as GibabitEthernet, has provoked considerable interest in the industry due to the possibilities these systems open to the dissemination of advertisements or rebroadcasting of events (news, sporting events, etc.), in turn significantly increasing the quality perceived by the user, making the railway trip more comfortable.

For all these reasons, different telecommunications systems have been developed envisaged to link with moving vehicles. Normally, the principle used is based on some radiofrequency transmitters and repeaters, distributed along the track, along which the convoys run. In this way, there is no need to install laid cable inside the carriages, from the previous video transmitter to the terminals distributed throughout the convoy, since the latter may have, directly or in groups, for example in carriages, a radiofrequency receiver receiving the broadcast signal and channelling it towards the terminals or television screens.

The main obstacle to be solved with these systems is the elimination of shadow areas, especially when the layout runs along underground tracks, like in underground metropolitan railways, where the difficulty of making the radio-frequency signal arrive at the receivers located in the convoy carriages becomes a maximum.

One solution known in the state-of-the-art is that described in the patent FR-A-2259490 (SIEMENS) related to a device for broadcasting signals between a vehicle and a fixed apparatus comprising a coaxial cable equipped with an external split conductor and arranged along the track of the moving vehicle and integrated into a metallic conducting body, in the dispersion field, through which an antenna joined to the vehicle moves. The patent document DE-A-195 41 650 (SIEMENS) describes an antenna in the form of a cable for improved signal transmission with respect to the first example mentioned, indicating likewise, in its descriptive report the disclosure in the publication “French Railway Review” Vol. 2 No 6, 1984 on pages 395 to 400, of a video camera system installed on a platform intended to send a signal by a connection or radiofrequency link with the information of said video cameras to a monitor installed inside a railway. An advertising system applied to suburban railways is also known and described in patent ES-A-2147126 (Mas Marimon) using the mentioned radial transmitter cable laid along the runs themselves of the suburban railway convoys, next to which receiving antennas mounted on said railway pass, using as a transmitter an audio visual player and foreseeing an omni-directional antenna for each exhibiting unit or screen.

The solutions described have the disadvantage of having to deploy the mentioned radial transmitter cable along the railway track, with the disadvantages this involves, not only economic, but also in terms of installation and maintenance. However, this invention represents an original solution avoiding the installation and laying of the mentioned transmitter cable, permitting at the same time, on many occasions, taking advantage of other pre-existing installations on the metropolitan railway stations, hence being an advance with respect to the state-of-the-art known from which important benefits are derived on technically improving the system, as well as considerably reducing installation cost.

This invention consists of a video signal broadcasting system and in general, of video images and sound in real time, especially applicable to railways and more particularly, to suburban ones.

The system is based on the transmission of the mentioned contents (video images and sound) in a high compression format which will be detailed later on, through a wireless network of Wireless Ethernet access points with 54 Mbit/s capacity, deployed along the suburban railway tunnels.

The system proposed is a video signal broadcasting system to carriages of a railway convoy, for example, underground metropolitan, equipped with terminals in the form of television screens and sound, consisting of a transmitter head subsystem for the signal to be displayed, a transmission subsystem responsible for sending the signal to the carriages and an onboard equipment subsystem, inside the convoy carriages. In the system proposed, the three mentioned subsystems are coordinated to each other, the mentioned head subsystem consisting of a video signal receiver device, receiving from a remote production or diffusion centre, said video signal being coded in MPEG2 format and inserted in a local Ethernet network, preferably a GigabitEthernet network, available in the metropolitan railway network, useful to send information to the platforms, while the broadcasting subsystem consists of a transmitter device located in each station, connected to a port of the router of each station of the GigabitEthernet network, which may already exist and the onboard system in the trains consisting of a receiver and control exchange, power supply and TFTs or terminal screens.

Likewise, the mentioned transmission subsystem covers all the tunnel topology, as the mentioned transmitter devices located in each station, being formed by three antennas: two one-way antennas at each end of the tunnel and an omni-directional one to cover the station, it being possible, according to the distance and tunnel topology, that an extra antenna may exist in some intermediate point of the tunnel.

Moreover, in the mentioned onboard subsystem in trains, the mentioned control exchange has a Wireless Ethernet card, which receives the contents transmitted by the previous antennas covering the railway network, having a specific computer programme, which decodes the compressed signal in MPEG2 format, converting it into an adequate means to be displayed by the TFTs or terminal screens. This subsystem has a monitoring and control system, which allows at all times to know the operational status of the entire assembly.

Below, a detailed description of the video signal transmission system in railways, purpose of this invention, will be made by referring to the attached drawings, which, represent as an example and without limitation, a preferred embodiment, susceptible of all those variations of detail which do not involve a basic alteration of the essential characteristics of said improvements.

Said plans show:

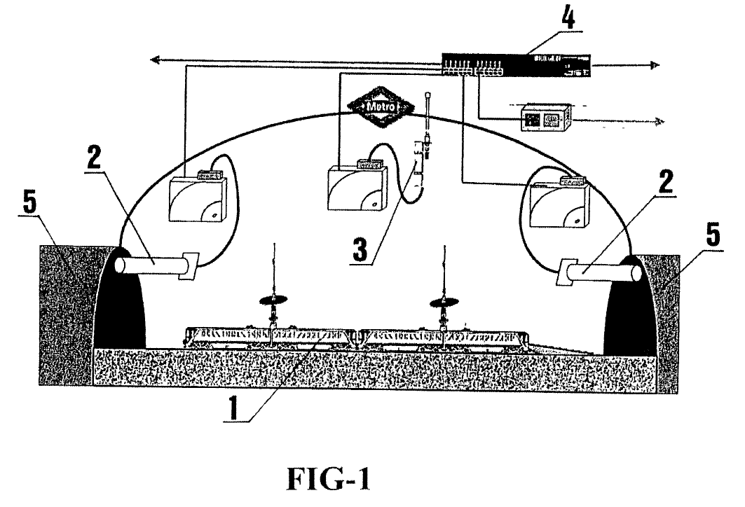

FIG. 1: schematic view of the video signal broadcasting system installed in an underground railway station, such as the metropolitan railway.

According to the execution example shown, the video-signal broadcasting system in railways shown in this preferred embodiment basically consists of a video and sound signal broadcasting system to the carriages (1) of a metropolitan railway convoy, equipped with terminals, such as television and sound screens, composed of a signal transmitter head subsystem, a transmission subsystem responsible for sending the signal to the carriages and an onboard equipment subsystem, inside the convoy carriages. In this system, the three mentioned subsystems are coordinated to each other, the mentioned head subsystem consisting of a video signal receiving device from a remote production or diffusion centre, this video signal being coded in MPEG2 format and inserted in the GigabitEthernet telecommunications network that may already be available in the metropolitan railway network (to send the signal to stations), whilst the transmission subsystem consists of a transmitter device (4) located in each station, and connected to the port of the router of each station of the normally pre-existing Gigabit network and the onboard subsystem in trains consists of a receiving and control exchange, power supply and TFTs or terminal screens.

Likewise, the mentioned transmission subsystem (4) covers all tunnel topology as the mentioned transmitter device is located in each station, being formed by three antennas: two one-way (2) at the end of each tunnel (5) and an omni-directional one (3) to give coverage to the station, it being possible, according to the distance and tunnel topology, to install another antenna at an intermediate point of the tunnel.

Moreover, in the mentioned onboard subsystem in trains, said control centre has a Wireless Ethernet card, receiving the contents transmitted by the previous antennas covering the metropolitan railway network, having a specific computer programme which decodes the compressed signal in MPEG2 format, converting it to a suitable means to be displayed by the TFTs or terminals. The assembly has a monitoring and control system which, at all times, allows the operation status of the system to be known.

Having sufficiently described the components of the invention and their functional interrelation for its understanding and implementation by an expert in the matter. The invention is further made extensive to the essential aspects detailed in the following claims.

1.- A video and sound signal broadcasting system applicable to railways, consisting of a video-signal transmission system to carriages (1) of an underground metropolitan railway convoy, equipped with terminals in the form of television screens and sound, consisting of a signal transmitter head subsystem, a transmission subsystem responsible for sending the signal to the carriages and an onboard equipment subsystem, inside the convoy carriages, characterised in that the three mentioned subsystems are co-ordinated to each other, the mentioned head subsystem consisting of a video-signal receiver device, receiving from a remote production or diffusion centre, said video signal being coded in MPEG2 format and inserted in a local Wireless Ethernet telecommunication network, deployed along the tunnels of a railway network, whilst the transmission subsystem consists of a transmitter device (4), located in each station and connected to a port of the router of each station of said Wireless Ethernet network and the onboard subsystem in the trains, consisting of a control and reception exchange, power supply and some TFTs or terminal screens.

2.- A system, according to claim 1, characterised in that the mentioned local Wireless Ethernet telecommunications network is a GigaEthernet network

3.- A system according to the first claim, characterised in that the mentioned transmission subsystem (4) covers all the tunnel topology, including at least one transmitter device located in each station, formed by three antennas: two one-way ones (2) at the end of each tunnel (5) and an omni-directional one (3) to give coverage to the station, it being possible according to the distance and tunnel topology that an additional antenna exists at an intermediate point of said tunnel.

4.- A system according to some of the previous claims, characterised in that in said onboard subsystem in trains, the mentioned control receiver exchange has a Wireless Ethernet card foreseen to receive the contents transmitted by the previous antennas covering the railway network, having the latter an applied and specific computer programme which decodes the compressed signal in MPEG2 format, converting it to a suitable means to be display by the TFTs or terminal screens.

5.- A system, according to claim 4, characterised in that the onboard subsystem assembly has a monitoring and control equipment allowing to know, at all times, the operational status of the entire system.
